(19) United States
(12) Patent Application Publication
(10) Pub. No.: US 2025/0005305 A1
(43) Pub. Date: Jan. 2, 2025

(54) AUTOMATED ELECTRONIC DATA INTERCHANGE MAPPING AND TRANSLATION

(71) Applicant: INTERNATIONAL BUSINESS MACHINES CORPORATION, Armonk, NY (US)

(72) Inventors: Sthanikam Santhosh Kumar, Punganuru (IN); Shailaja D N, Bangalore (IN); Koosappa M, Bangalore (IN); Karthikeyan R, Bangalore (IN); Bharatesh Biradarpatil, Jamkhandi (IN); Rishabh Garg, Navi Mumbai (IN); Supriya Devidutta, Bhubaneswar (IN)

(21) Appl. No.: 18/346,118

(22) Filed: Jun. 30, 2023

(51) Int. Cl. G06F 40/58; G06F 40/55

(52) U.S. Cl. CPC G06F 40/58; G06F 40/55

(57) ABSTRACT

Automated development of an electronic data interchange (EDI) translator includes mapping, by a first machine learning model, source fields of documents formatted according to a first EDI format to destination fields of documents formatted according to a second EDI format. A mapping requirements specification is translated by a second machine learning model into code executable by a computer processor. A translation object is generated based on the mapping and translating. The translation object is used by an EDI translator that translates documents formatted according to the first EDI format into documents formatted according to the second EDI format is generated based on the mapping and translating.

### BACKGROUND

This disclosure relates to electronic data interchange (EDI), and more particularly, to using machine learning for automated assistance developing EDI mappings and translations.

EDI is the automated exchange of electronic data between computer systems using a specific format following specific data-content rules. Standards set by an EDI format define the location and order of information within an electronic document. The exchange of electronic documents according to an EDI format is generally more efficient than exchanging paper-based documents. EDI is widely used by businesses, governmental organizations, and others to convey information from a computer application of one entity's computer system to a computer application of another entity's computer system.

### SUMMARY

In one or more embodiments, a method includes determining, by a first machine learning model, a mapping of source fields of documents formatted according to a first EDI format to destination fields of documents formatted according to a second EDI format. The method includes translating, by a second machine learning model, a mapping requirements specification (MRS) into code executable by a computer processor for processing documents formatted according to the second EDI format. The method includes generating, based on the mapping and the translating, a translation object used by an EDI translator to translate documents formatted according to the first EDI format into documents formatted according to the second EDI format.

In one or more embodiments, a system includes one or more processors configured to initiate executable operations. The operations include determining, by a first machine learning model, a mapping of source fields of documents formatted according to a first EDI format to destination fields of documents formatted according to a second EDI format. The operations include translating, by a second machine learning model, a mapping requirements specification (MRS) into code executable by a computer processor for processing documents formatted according to the second EDI format. The operations include generating, based on the mapping and translating, a translation object used by an EDI translator to translate documents formatted according to the first EDI format into documents formatted according to the second EDI format.

In one or more embodiments, a computer program product includes one or more computer-readable storage media and program instructions collectively stored on the one or more computer-readable storage media. The program instructions are executable by a processor to cause the processor to initiate operations. The operations include determining, by a first machine learning model, a mapping of source fields of documents formatted according to a first EDI format to destination fields of documents formatted according to a second EDI format. The operations include translating, by a second machine learning model, a mapping requirements specification (MRS) into code executable by a computer processor for processing documents formatted according to the second EDI format. The operations include generating, based on the mapping and translating, a translation object used by an EDI translator to translate documents formatted according to the first EDI format into documents formatted according to the second EDI format.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing a conditional cognitive EDI translation (CCEDIT) framework 200.

FIG. 2 illustrates an example architecture of the executable CCEDIT framework of FIG. 1.

FIG. 3 illustrates an example method of operation of the CCEDIT framework illustrated in FIGS. 1 and 2.

FIG. 4 illustrates certain operative aspects of the CCEDIT framework illustrated in FIGS. 1 and 2.

FIGS. 5A-5C illustrate certain operative aspects of the CCEDIT framework illustrated in FIGS. 1 and 2.

FIG. 6 illustrates certain operative aspects of the CCEDIT framework illustrated in FIGS. 1 and 2.

### DETAILED DESCRIPTION

While the disclosure concludes with claims defining novel features, it is believed that the various features described within this disclosure will be better understood from consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to electronic data interchange (EDI), and more particularly, to using machine learning for automated assistance developing EDI mappings and translations. Unless two entities use the same EDI format, of which there are several, the entities' exchange of EDI documents requires conversion from one EDI format to another. Moreover, the two entities may use different computer systems, such as an entity-specific enterprise resource planning (ERP) or other back-end data processing system, which the EDI conversion also must accommodate.

These tasks are handled by an EDI translator. When data being sent by one entity is exported from that sending entity's ERP (or other system) to a file, the EDI translator maps the data to the EDI format specified by the receiving entity. Creating the EDI mapping requires an understanding of the EDI format, such as X12, EDIFACT, or other EDI formats.

The EDI translator's mapping likely must also include conditional logic as well. For example, if the sending entity is conveying a shipping notification, the conditional logic is needed to determine how the shipped items are packaged. Or if receiving a purchase order, the conditional logic may be needed to check whether there is current inventory to fulfill the order. Thus, the EDI translator also should include conditional logic in its mapping.

The EDI translator is a system component for entities that exchange differently formatted EDI documents and that use differently structured ERPs or other back-end systems to process EDI documents. Indeed, even if two entities' systems use the same EDI formatting, an EDI translator is typically relied on by each to ensure that the EDI documents are structured in a way that complies with the requirement of and is compatible with each entities' ERP or other back-end system given that the different systems may have different hardware and/or software requirements.

Understandably, the development of an EDI translator is complex and highly resource intensive. Development of the EDI translator requires a considerable investment of system resources and extensive domain knowledge, encompassing not only EDI formats and standards, but data structures, and entity-specific hardware and/or software system requirements as well.

In accordance with the inventive arrangements disclosed herein, methods, systems, and computer program products are provided that are capable of generating an EDI translator. In certain embodiments, the inventive arrangements determine, by a first machine learning model, a mapping. The mapping maps the source fields of documents formatted according to a first electronic data interchange (EDI) format to destination fields of documents formatted according to a second EDI format. A second machine learning model translates a mapping requirements specification (MRS) into code executable by a computer processor for processing documents formatted according to the second EDI format. Based on the mapping and conditional logic, the inventive arrangements generate a translation object. The translation object is used by EDI translator is capable of translating documents formatted according to the first EDI format into documents formatted according to the second EDI format.

The inventive arrangements thus automate entirely, or nearly so, the process of generating an EDI transformer by providing a translation object to map source fields according to one EDI format to destination fields according to a different EDI format. The translation object provided by the inventive arrangements also translates a natural language description of conditional logic (e.g., business specific logic) into code that implements the conditional logic when executed by a computer processor. When development of an EDI translator is performed in a conventional manner, it involves tasks that require considerable time and effort. Typically, it is performed by developers, who must have an in-depth understanding of different EDI formats and entity-specific ERP or other back-end system requirements. With the inventive arrangements, the cognition of a human developer is augmented, or largely supplanted, by machine-implemented cognition using machine learning to provide format mappings and translation of natural language into code. The inventive arrangements thus provide a two-stage cognitive solution for automating the process of EDI development.

In one aspect, the first machine learning model is a language model that determines the mapping based on natural language descriptions of the source and destination fields. The first machine learning model in certain embodiments implements a language model that is a conditional transformer language model which controllably determines the mapping based on the natural language descriptions.

The machine learning models implemented as language models, especially implemented as a conditional transformer language model, may be trained using very large sets of training examples. The large-set training considerably increases the accuracy of the EDI translator generated by the inventive arrangements. For conventional techniques to achieve accuracy comparable to that acquired with large-set machine learning would require a human developer having many years of experience translating EDI formats and having vast knowledge of various entity-specific systems. The same attributes, however, are acquired rapidly and efficiently by the machine learning implemented by the inventive arrangements.

In another aspect, the MRS provides a natural language description of conditional logic, and the second machine learning model is a language model that translates the natural language description into code. The natural language descriptions can describe context-specific requirements that are specific to system requirements of a computer system of a predetermined entity that exchanges EDI documents that may be differently formatted. The second machine learning model, in certain embodiments, implements a language model that is a conditional transformer language model that controllably translates the context-specific requirements into conditional logic based on the natural language descriptions of the MRS.

The second machine learning model understands natural language descriptions of conditional logic, such as business specific logic, and system requirements. The second machine learning model, implemented as a generative language model, can translate the natural language descriptions into executable code, the conditional logic. The second machine learning model learns to understand and translate natural language into executable code through machine learning, obviating the need for an expert versed in various system requirements. Through machine learning, the second machine learning rapidly and accurately learns the correct translations and may do so for a large number of different systems. A natural language description may describe a specific scenario such as a business scenario (e.g., B2B scenario). The second machine learning model can rapidly and efficiently translate the natural language description into executable code for performing EDI document exchange in accordance with the described scenario.

In another aspect, the inventive arrangements present a schematic of the mapping to a user via a user interface and the mapping may be revised in response to user input via the user interface. The inventive arrangements may determine that alternative paths map one source field of a document formatted according to the first EDI format to two or more destination fields of a document formatted according to the second EDI format. In response to detecting alternative paths, the inventive arrangements automatically select one of the alternative paths based on natural language descriptions of the fields. The inventive arrangements may present a schematic of the mapping to a user via a user interface. The user may confirm the path selection or revise the mapping by selecting via the user interface a different alternative path. Thus, the inventive arrangements, while automating the generation of an EDI translator, nonetheless may receive and implement user input as well.

In another aspect, a specific source field is mapped to a corresponding destination field using rule-based logic in response to the inventive arrangements determining that there is an unambiguous, single path between the specific source and corresponding destination fields. Implementing rule-based logic when it can be used enables inventive arrangements to conserve processing resources. Accordingly, the inventive arrangements may converse resource until needed for more resource-intense processing required by the machine learning models, using added resources only as necessary.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

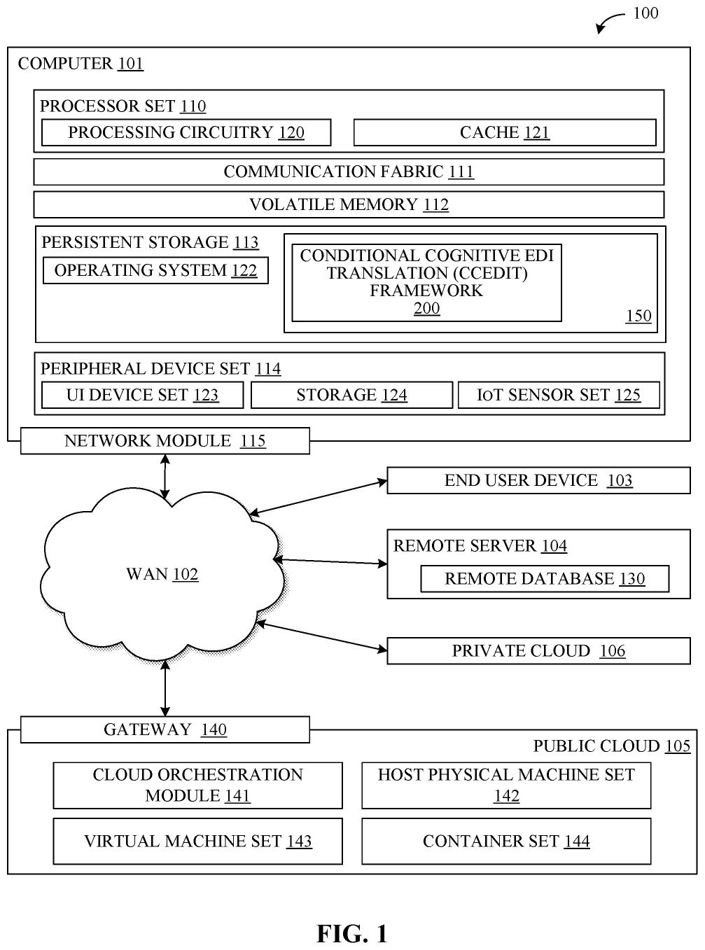

Referring to FIG. 1, computing environment 100 contains an example of an environment for the execution of at least some of the computer code in block 150 involved in performing the inventive methods, such as conditional cognitive EDI translation (CCEDIT) framework 200 implemented as executable program code or instructions. CCEDIT framework 200 provides conditional map generation for translating one EDI document from one format into a different format. Using machine learning models, CCEDIT framework 200 provides for automated end-to-end EDI translations that require no human involvement or, in the alternative, minimal human involvement. CCEDIT framework 200, using machine learning models, formats an EDI document to include executable code-implemented conditional logic in accordance with the format, layout, and hierarchy of tags used by the ERP or other system of the entity receiving the EDI document. The conditional logic can implement specific scenarios involving different entities that exchange EDI documents.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CCEDIT framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

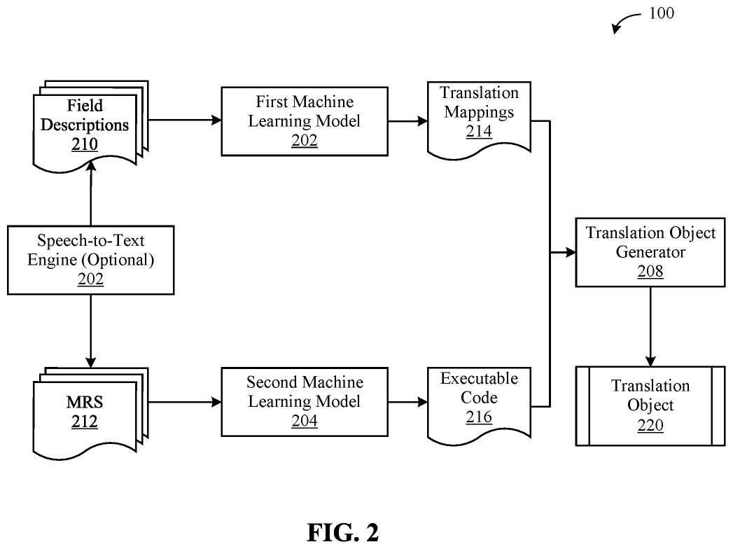

FIG. 2 illustrates an example architecture for the executable CCEDIT framework 200 of FIG. 1. In the example of FIG. 2, CCEDIT framework 200 illustratively includes first machine learning model 202, second machine learning model 204, and translation object generator 208. CCEDIT framework 200 optionally also includes speech-to-text engine 218. A developer of EDI translators or other user may provide input via text or speech input to a user interface of the computer system used to implement CCEDIT framework 200. If the input is spoken by the developer or other user, then optional speech-to-text 218 converts the developer or user's speech to text.

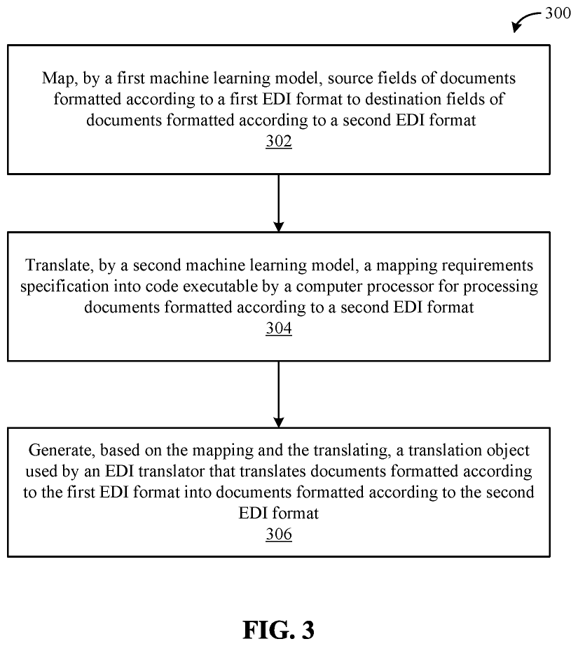

FIG. 3 illustrates an example method 300 of operation of the CCEDIT framework 200 of FIGS. 1 and 2. CCEDIT framework 200 operates with respect to the input of the developer or other user. The input includes field descriptions 210. Field descriptions 210 are natural (human) language descriptions that describe source fields of documents formatted according to a first EDI format to destination fields of documents formatted according to a second EDI format. Each segment of an EDI-formatted document comprises one or more elements distinguished by terminators or separators, often though without line breaks, punctuation, or other symbols to make the document intelligible to a reader. Moreover, the fields comprising the segments differ from one EDI format to another.

Even if the entity receiving an EDI-formatted document uses the same format that the sending entity uses to format its documents, the receiving entity may not necessarily follow the same formatting standards as the sending entity. Other entities may implement different versions of the format layout of document. Different entities may utilize systems that implement different conditional logic, that is, code executable by a computer processor for performing certain functions in a certain manner. Accordingly, input of the developer or user may also include mapping requirements specification (MRS) 212.

MRS 212 is a natural language description of conditional logic. The conditional logic corresponds to the processor-implemented logic of an ERP or other system used by an entity in processing EDI-formatted documents. Although MRS 212 does not include any executable program code itself, MRS 212 does provide, in natural language, descriptions of conditional logic and requirements of ERP or other back-end systems. The conditional logic is executable code executed by a specific entity's ERP or other back-end system in processing documents formatted according to one or more EDI formats. The natural language of MRS 212 can describe context-specific requirements of certain code executed by a specific entity's ERP or other back-end system in processing documents formatted according to one or more EDI formats. In one or more embodiments, executable code-implemented “conditional logic” defines business-specific logic. Business-specific logic prescribes the way that business objects such as accounts, documents, and the like interact with one another and dictates the routes and methods by which business objects are accessed and updated by a computing system, such as an ERP or other back-end system. For example, conditional logic can determine how in response to sending a shipping notification the item shipped is packaged. Conditional logic, for example, can determine whether items specified in a received purchase order are currently in the entity's inventory. Thus, the business objects may include a shipping notification object, packaging instruction object, and the like. The business-specific logic can guide the interaction between business entities by defining the communications exchanged and/or the content of communications among the objects between different computer systems over a network or other communications link.

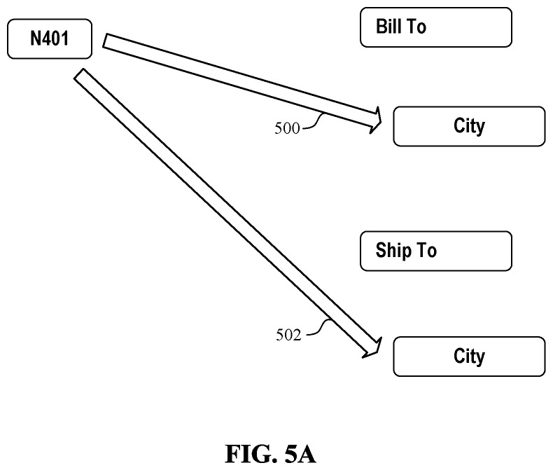

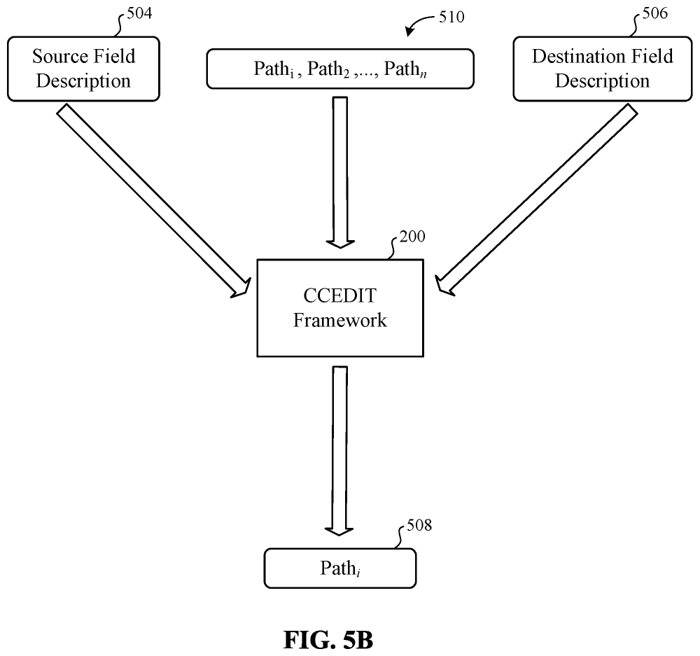

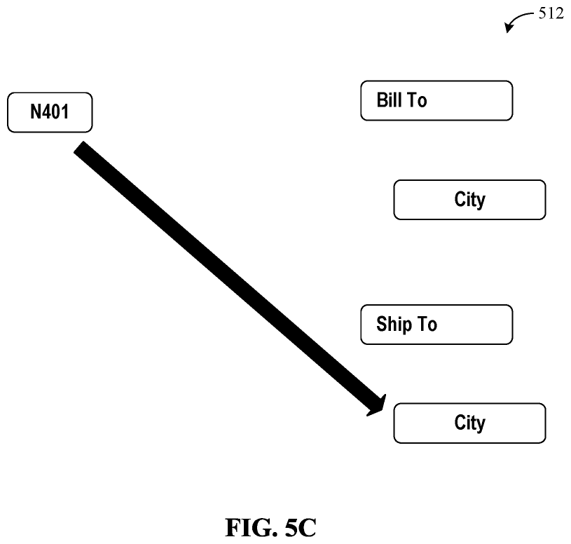

Referring to FIGS. 2 and 3 collectively, in block 302, first machine learning model 202 maps fields of documents formatted according to a first EDI format to fields of documents formatted according to a second EDI format. The fields of a document formatted according to the first EDI format are designated source fields. The fields of a document formatted according to the second EDI format are designated destination fields. First machine learning model 202 is trained to determine a path from a source field to a destination field (FIGS. 5A-5C), generating translation mappings 214. Translation mappings 214 map source fields of documents formatted according to the first electronic data interchange (EDI) format to destination fields of documents formatted according to the second EDI format.

In certain embodiments, first machine learning model 202 is a language model. First machine learning model 202 is trained through machine learning to map source fields of documents formatted according to the EDI format to destination fields of documents formatted according to the second EDI format based on natural language descriptions of the source and destination fields.

First machine learning model 202, in certain embodiments, is implemented using a transformer architecture for the language model. An advantage of the transformer architecture is more rapid training through parallelization where learning text occurs in parallel steps as opposed to sequentially. Another advantage is implementation of an attention mechanism enabling first machine learning model 202 to learn which portions of input should be accorded more attention than others.

In certain embodiments, first machine learning model 202 is implemented as a conditional transformer language model. First machine learning model 202, implemented as a conditional transformer language model, may be trained to condition on control codes that govern the content and task-specific behavior of the model. Control codes of first machine learning model 202 may be derived from structure that naturally co-occurs within training examples of field descriptions and enable first machine learning model to accurately predict paths between fields of differently formatted documents based on text-based descriptions of the fields. Thus, implemented as a conditional transformer language model, first machine learning model 202 controllably determines the mappings based on natural language descriptions 210.

In block 304, second machine learning model 204, translates context-specific requirements specified in natural language input of MRS 212. Second machine learning model 204 thus translates the natural language description of the context-specific requirements into executable code 216, that is, code executable by a computer processor for processing documents formatted according to the second EDI format. The conditional logic is validated and implemented by an EDI translator prior to performing a translation of data from one format to another. The conditional logic specified in a natural language description of MRS 212, if it is context-specific, may specify requirements that dictate processing actions of an ERP or other back-end system of entities that exchange documents using different EDI formats, conditional logic embedded in the EDI formatted documents. For example, the context-specific requirements may relate to a particular B2B scenario in which one entity receives a purchase order from another entity and responds by sending a shipping notification, the purchase order and shipping notification conveyed in differently formatted EDI documents. The EDI documents can each embed the conditional logic as processor-executable code. The processor-executable code initiates actions performed by the respective entities' systems in processing the documents according to specification of their respective computer systems.

In the context of the B2B scenario in which one entity receives a purchase order from another entity and responds by sending a shipping notification, for example, the context-specific requirements specified in the natural language of MRS 212 may specify that processing an invoice requires a Purchase Order Number field having eight characters. Otherwise, the processing fails. The context-specific description may specify that if a type of the item is computer hardware, then the shipping address is taken from a Ship To Address field. The context-specific description may specify that the Ship To Address field maps to a Sold To Address field.

Machine learning model 204 understands from the natural language description of context-specific requirements the locations within the Invoice of the Purchase Order Number field, the Ship To Address field, Sold to Address field, as well as where Item details are present in the Invoice. Machine learning model 204 translates the description into executable code 216. An example translation of MRS 212 by second machine learning model 200 is the following code:

If len(#OrderNumber ) = 8 then
#Temp_OrderNumber= #OrderNumber
Else
cerror(100,#OrderNumber,”Purchase Order Number is Invalid”)
If(#Item_Type) = “HW” then
#Temp_AdressLine1= $Shipt_To.#AddressLine1
#Temp_AddressLine2= $Ship_To.#AddressLine2
#Temp_City=$Ship_To.#City
If(#Item_Type) != “HW” then
#Temp_AdressLine1= $Sold_To.#AddressLine1
#Temp_AddressLine2= $Sold_To.#AddressLine2
#Temp_City=$Sold_To.#City
If exist($Item.#Subline) then
$Temp_Item[ ].#Temp_Subitem=$Subline[ ].#Subline

Thus, machine learning model 204 learns to translate MRS 212, including natural language descriptions of context-specific requirements, into executable code as illustrated by the example B2B scenario described.

In block 306, Translation object generator 208 generates and outputs translation object 220. Translation object generator 208 generates translation object 220 based on inputs of translation mapping 214 and executable code 216. Translation object 220 is a software object that provides a mapping. The mapping is from fields specified by one EDI format to corresponding fields specified by a different EDI format. The mapping, additionally, is from one or more natural language descriptions of conditional logic to executable code that implements the conditional logic when executed by a computer processor. Translation object 220 is generated by the two-stage cognitive solution implemented in CCEDIT framework 200. Implemented in an EDI translator, translation object 220 correctly maps source fields to destination fields to translate from one EDI format to another and correctly translates conditional logic in machine executable code in a format understandable by the EDI translator. In accordance with certain embodiments, CCEDIT framework 200 may generate translation object 220 as source code comprising input fields, output fields, a mapping instruction to map between the input and output fields, and conditional logic (e.g., to execute business-specific scenarios).

The EDI translator, implementing translation object 220, comprises processor-executable code that translates documents formatted according to the first EDI format into documents formatted according to the second EDI format. Implementing translation object 220, the EDI translator provides processor-executable code that implements the conditional logic described in natural language. In some embodiments, EDI translator is a component of a B2B integrator or other transaction engine that runs user-defined processes and manages the processes according to user-proscribed requirements.

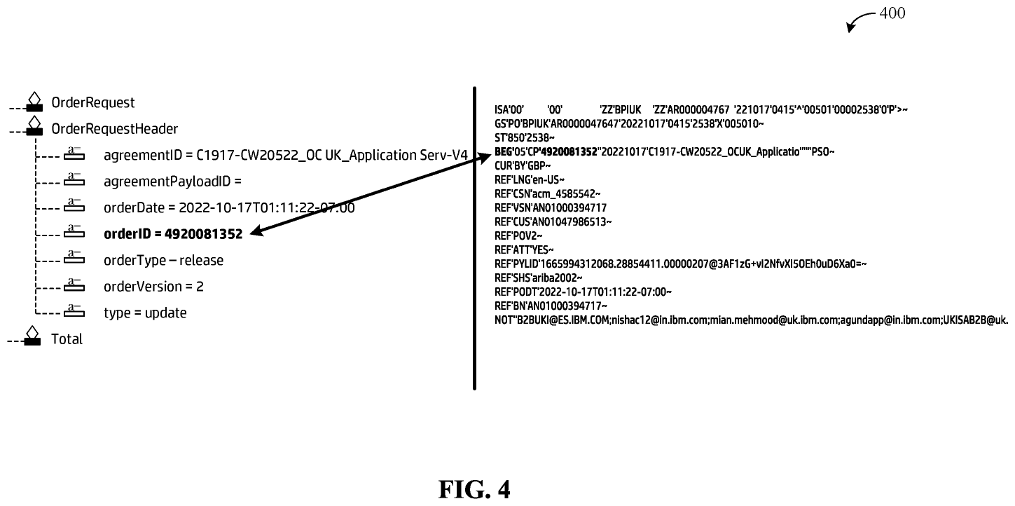

FIG. 4 illustrates a mapping from X12 field BEG03, a field in X12-formatted documents for a purchase order number, via path 400, to the corresponding cXML field. Illustratively, there is only a single path, path 400, that maps the respective fields to one another. Optionally, CCEDIT 200 determines fields for which there is unambiguously a single path between corresponding fields, and in response to the determination, applies rule-based logic for determining the appropriate mapping. Because there is no ambiguity, there is no need for translating a natural language description of the fields to determine the correct path. In instances where there is ambiguity, CCEDIT 200 relies on first machine learning 202 to predict a correct path based on a natural language description of the fields formatted according to different EDI formats.

FIGS. 5A-5C illustrate a situation in which there are alternative paths between fields of two differently formatted documents. FIG. 5A schematically illustrates the situation whereby the X12 field N401, a field in X12-formatted documents specifying geographic location, ambiguously maps to either a Bill To city field (via path 500) or a Ship To city field (via path 502) of a differently formatted document. Typically, with conventional techniques, a human developer must resolve the ambiguity and attempt to select the correct path to map the X12 field to the appropriate field of the differently formatted document. A human developer must have considerable expertise to make the correct selection. By contrast, CCEDIT framework 200 makes the selection using first machine learning model 202. As a language model, especially a conditional transformer language model, first machine learning model 202 can be trained using a very large number of training examples.

FIG. 5B schematically illustrates the operations of CCEDIT framework 200. Based on source field description 504 of the N410 field and destination field description 506, describing the field as one at which an entity receiving the differently formatted document accepts shipments, CCEDIT framework 200 selects i-th path 508 from among n alternative paths 510.

FIG. 5C schematically illustrates the path selected by CCEDIT framework 200 based on source field description 504 of the N410 field and destination field description 506. Detecting the ambiguity illustrated in FIG. 5A, CCEDIT framework 200 automatically resolves the ambiguity illustrated by selecting the Ship To city field based on the natural language descriptions of the source and destination fields.

Optionally, CCEDIT framework 200 presents to an EDI developer or other user via a user interface, such as graphical user interface (GUI), a display showing the multiple paths. In response to detecting an ambiguity CCEDIT framework 200 resolves the ambiguity by selecting a path, the selection by CCEDIT framework 200 based on a machine learning model understanding of the natural language descriptions of the source and destination fields. Optionally displaying the alternative paths and the machine-determined selection on the GUI, CCEDIT framework 200 enables the user to confirm the selection or revise it. The user revises a machine-generated mapping by selecting a different path between two differently EDI-formatted fields. For example, to revise the mapping via GUI display 512, the user may reposition the path from the Ship To city field to the Bill To city field.

Thus, in determining a mapping by first machine learning model 202, CCEDIT framework 200 may detect alternative paths mapping one source field to two or more destination fields. Based on the natural language field descriptions 210, first machine learning model 202 selects one of the alternative paths. CCEDIT framework 200 optionally presents (e.g., via a GUI display) a schematic of the mapping to a user. The user may confirm the selection by first machine learning model 202 or revise the mapping. The user revises the mapping by selecting a different one of the alternate paths.

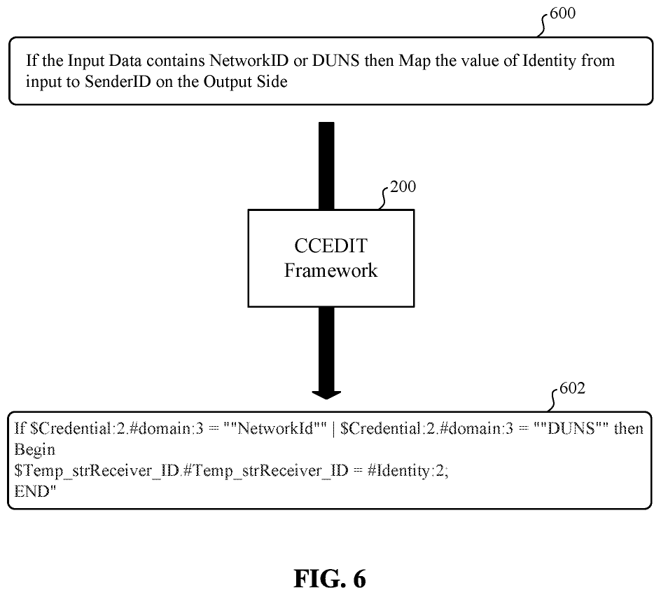

FIG. 6 illustrates certain operative aspects of CCEDIT 200. Illustratively, MRS 212 includes the natural language specification in block 600. Second machine learning model 204 converts the natural language specification of block 600 to code recognized by EDI transform 206. EDI transformer 206 can include code within a translation of an EDI document formatted in a first EDI format into an EDI document formatted in a second EDI format. Code is executable by a computer processor of an entity receiving the EDI document formatted in the second EDI format, the code having format, layout, and hierarchy of tags processable by the receiving entity's ERP or other system.

The terminology used herein is for the purpose of describing particular embodiments only and is not intended to be limiting. Notwithstanding, several definitions that apply throughout this document will now be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C.” “at least one of A. B, or C,” “one or more of A, B, and C.” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including.” “comprises,” and/or “comprising.” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by a first machine learning model, a mapping of source fields of documents formatted according to a first electronic data interchange (EDI) format to destination fields of documents formatted according to a second EDI format;
translating, by a second machine learning model, a mapping requirements specification (MRS) into code executable by a computer processor for processing documents formatted according to the second EDI format; and
generating, based on the mapping and the translating, a translation object used by an EDI translator to translate documents formatted according to the first EDI format into documents formatted according to the second EDI format.

2. The computer-implemented method of claim 1, wherein the first machine learning model is a language model that determines the mapping based on natural language descriptions of the source and destination fields.

3. The computer implemented method of claim 2, wherein the language model is a conditional transformer language model that controllably determines the mapping based on the natural language descriptions

4. The computer-implemented method of claim 1, wherein the MRS includes a natural language description of context-specific requirements, and wherein the second machine learning model is a language model that translates the natural language description of context-specific requirements into code executable by the processor.

5. The computer-implemented method of claim 4, wherein the language model is a conditional transformer language model that controllably translates the natural language descriptions of context-specific requirements.

6. The computer-implemented method of claim 4, wherein the context-specific requirements are specific to system requirements of a computer system of a predetermined entity that exchanges documents formatted according to one or more EDI formats.

7. The computer-implemented method of claim 1, wherein the determining a mapping by the first machine learning model includes detecting a plurality of alternative paths mapping one source field of the document formatted according to the first EDI format to two or more destination fields of the document formatted according to the second EDI format and automatically selecting one of the plurality of alternative paths, and wherein the method further includes:
presenting a schematic of the mapping to a user via a user interface; and
revising the mapping in response to user input via the user interface, wherein the user input revises the mapping by selecting a different one of the plurality of alternate paths.

8. The computer-implemented method of claim 1, wherein a specific source field is mapped to a corresponding destination field using rule-based logic in response to determining that there is an unambiguous, single path between the specific source and corresponding destination fields.

9. A system, comprising:
one or more processors configured to initiate operations including:
determining, by a first machine learning model, a mapping of source fields of documents formatted according to a first electronic data interchange (EDI) format to destination fields of documents formatted according to a second EDI format;
translating, by a second machine learning model, a mapping requirements specification (MRS) into code executable by a computer processor for processing documents formatted according to the second EDI format; and
generating, based on the mapping and the translating, a translation object used by an EDI translator to translate documents formatted according to the first EDI format into documents formatted according to the second EDI format.

10. The system of claim 9, wherein the first machine learning model is a language model that determines the mapping based on natural language descriptions of the source and destination fields.

11. The system of claim 10, wherein the language model is a conditional transformer language model that controllably determines the mapping based on the natural language descriptions

12. The system of claim 9, wherein the MRS includes a natural language description of context-specific requirements, and wherein the second machine learning model is a language model that translates the natural language description of context-specific requirements into code executable by the processor.

13. The system of claim 12, wherein the language model is a conditional transformer language model that controllably translates the natural language descriptions of context-specific requirements.

14. The system of claim 12, wherein the context-specific requirements are specific to system requirements of a computer system of predetermined entity that exchanges documents formatted according to one or more EDI formats.

15. The system of claim 9, wherein the determining a mapping by the first machine learning model includes detecting a plurality of alternative paths mapping one source field of the document formatted according to the first EDI format to two or more destination fields of the document formatted according to the second EDI format and automatically selecting one of the plurality of alternative paths, and wherein the one or more processors are configured to initiate operations further including:
presenting a schematic of the mapping to a user via a user interface; and
revising the mapping in response to user input via the user interface, wherein the user input revises the mapping by selecting a different one of the plurality of alternate paths.

16. The system of claim 9, wherein a specific source field is mapped to a corresponding destination field using rule-based logic in response to determining that there is an unambiguous, single path between the specific source and corresponding destination fields.

17. A computer program product, the computer program product comprising:
one or more computer-readable storage media and program instructions collectively stored on the one or more computer-readable storage media, the program instructions executable by a processor to cause the processor to initiate operations including:
determining, by a first machine learning model, a mapping of source fields of documents formatted according to a first electronic data interchange (EDI) format to destination fields of documents formatted according to a second EDI format;
translating, by a second machine learning model, a mapping requirements specification (MRS) into code executable by a computer processor for processing documents formatted according to the second EDI format; and
generating, based on the mapping and the translating, a translation object used by an EDI translator to translate documents formatted according to the first EDI format into documents formatted according to the second EDI format.

18. The computer program product of claim 17, wherein the first machine learning model is a language model that determines the mapping based on natural language descriptions of the source and destination fields.

19. The computer program product of claim 18, wherein the language model is a conditional transformer language model that controllably determines the mapping based on the natural language descriptions

20. The computer program product of claim 17, wherein the MRS includes a natural language description of context-specific requirements, and wherein the second machine learning model is a language model that translates the natural language description of context-specific requirements into code executable by the processor.
